(19) United States
(12) Patent Application Publication
(10) Pub. No.: US 2005/0017981 A1
(43) Pub. Date: Jan. 27, 2005

(54) Methods of representing gene product sequences and expression

(76) Inventors: Jonathan Bingham, San Francisco, CA (US); Subha Srinivasan, Greenbrae, CA (US)

Correspondence Address: PERKINS COIE LLP;PATENT-SEA, P.O. BOX 1247, SEATTLE, WA, 98111-1247, US

(21) Appl. No.: 10/802,530

(22) Filed: Mar. 17, 2004

Related U.S. Application Data
(60) Provisional application No. 60/455,525, filed on Mar. 17, 2003.

(51) Int. Cl. G09G 5/00

(52) U.S. Cl. 345/581

(57) ABSTRACT

A gene product representation technique combines gene product expression data with a genome browser or splice graph view of the gene product sequences. The representation technique indicates the expression level of a gene product, or region of a gene product, in the view in a graphical way. It may varies the color saturation of a portion of the gene product representation according to the expression level. The gene product representation may consist of a geometric shape, a text string, or a symbol. It may consist of multiple regions whose expression levels have been measured independently.

### CROSS REFERENCE TO RELATED APPLICATIONS

This application claims the benefit of provisional U.S. Patent Application No. 60/455,525, filed Mar. 17, 2003, which is hereby incorporated by reference in its entirety.

### TECHNICAL FIELD

The described technology relates generally to displaying representations of gene product sequences and expressions.

### BACKGROUND

A gene locus can be transcribed into multiple distinct polynucleotide sequences through a process known as alternate splicing. For example, a gene with 22 exons, 8 of which may be independently excluded or included during splicing, would lead to 2⁸ possible polynucleotide transcripts. Each polynucleotide may have a unique polypeptide translation. Some polypeptides may have additional protein domains, or missing domains, relative to other polypeptides. Likewise, some polypeptides may have different polypeptide subsequences in regions of interest, such as an active site. The polynucleotide splice variants themselves may exhibit varying, and even opposing, biological functions.

A conventional genome browser displays each sequence annotation as a graphical representation (e.g., a bar or series of bars) on a separate row or column in the display. To view the space of possibilities in a standard genome browser would thus require 2⁸ graphical representations-an unwieldy number. Actual splicing can be much more complicated, since a given exon may be trimmed, extended, excluded or included, and adjacent exons may vary coordinately.

An alternate representation technique called the “splicing graph” has been proposed, which represents splicing as a flow chart, each path of which indicates a unique splice form. However, in complex cases, the splicing graph may fail to yield a visually intuitive view.

It would be desirable to have an alternative representation, with the benefits of the splicing graph and the visual intuitiveness of the conventional genome browser. Such a representation would ideally derive from an automated process. It would identify and visually represent the complexity of splicing, including trims, extensions, exclusions, inclusions, covariation of adjacent alternately spliced modules, alternate 5′ starts and alternate 3′ tails.

The disparity in size between intronic and exonic regions, and between long exons and micro-exons, makes it difficult to simultaneously view the shortest and longest sequences. Existing genome browsers commonly display sequence annotations, such as exons, introns, RNAs and proteins, on a single consistent linear scale according to their length in bases. The scale can be changed for the entire display in order to zoom in or zoom out, but all individual base ranges are affected equally. As a result of the uniform scale, it is often difficult to see annotations of vastly different lengths at the same time. For example, intronic regions may be tens of thousands of bases long, whereas an exon may span only tens of bases. STS markers and glycosylation sites are but a few bases long, whereas BACs and chromosomes may be half a dozen orders of magnitude longer. When displayed in a conventional genome browser, the relative differences in annotation lengths can be obscured by the vast differences in scale.

Some solutions, such as offering a separate display window or area in which a highlighted region is presented at a higher magnification level, mitigate the problem somewhat by allowing two or more simultaneous views. Other solutions selectively exclude particular annotations, such as introns, to avoid the problem of varying lengths. It would be desirable to present information of interest in a single graphical view that retains information about relative scales.

In other applications of data visualization outside of sequence data, “context+focus” approaches have been explored. In context+focus visualizations, a region of the display is in focus, while the rest of the display provides context, but typically at a different scale. In biological applications, hyperbolic tree viewers have allowed users to zoom in on portions of a phylogenetic tree or other hierarchical data cluster. But hyperbolic projections distort the entire view space, and hence are not well suited when careful comparison of relative distances is desired. Also, context +focus techniques often work like a magnifying glass, in the sense that a single localized portion of the display is in focus. To highlight multiple regions of the display, other techniques are typically employed, such as multiple view areas and higher dimensional displays. It would be desirable to graphically represent polynucleotide and polypeptide sequences using the benefits of context+focus techniques while avoiding the shortcomings of distortion.

In a given biological sample, a subset of the possible gene products of each gene will in fact be expressed, and in varying quantities. Using standard representation techniques for gene and protein expression, such as the two-tissue scatter plot, the expression profile, or the heat map, it is not obvious how to differentiate among multiple gene products of the same gene. For example, even when gene expression is constant, the relative expression of the various RNA or protein splice forms may change. The expression level of one exon or splice isoform may decrease even as the expression of the gene increases. Well-studied examples exist in the literature, such as CD44 expression during the progression of colorectal cancer. Standard expression representation techniques do not take into account the permutations and complexities introduced by alternate splicing. They require separate visualizations for sequences and expression levels, typically a genome browser for the former and a heat map, scatter plot or profile plot for the latter. It would be desirable to represent sequence data and expression data simultaneously in a single display.

A gene or protein expression profile is commonly represented as a vector, with one element per sample. Each gene typically has but a single vector. When there are multiple gene products per gene, it is possible to create multiple vectors per gene, one per gene product. However, given the combinatorics of alternate splicing, it can be cumbersome or impractical to create a separate profile for all theoretical possibilities. It would be desirable to have a more compact method of representing expression profiles when a gene has multiple potential gene products.

### BRIEF DESCRIPTION OF THE DRAWINGS

FIG. 1 is a diagram that illustrates generic alignment.

FIG. 2 is a diagram that illustrates cDNA alignment.

FIG. 3 is a diagram that illustrates modules in genomic alignment.

FIG. 4 is a diagram that illustrates modules in cDNA alignment.

FIG. 5 is a diagram that illustrates regions constitutive and non-constitutive modules.

FIG. 6 is a diagram that illustrates graphical representations of a constitutive region.

FIG. 7 is a diagram that illustrates displaying of an exon or intron within a constitutive region.

FIG. 8 is a diagram that illustrates displaying of a unique combination of modules.

FIG. 9 is a diagram that illustrates displaying of a protein domain in a region.

FIG. 10 is a diagram that illustrates displaying of a representative gene product in one embodiment.

FIGS. 11, 12, 13 and 14 are diagrams that illustrate the displaying of subsequences that have been scaled.

FIG. 15 is a diagram that illustrates the displaying of a circular genome.

FIG. 16 is a diagram that illustrates the displaying of expression levels in a splice graph.

FIG. 17 is a diagram that illustrates the displaying of expression levels in a genome browser.

FIG. 18 is a diagram that illustrates other methods for displaying expression levels.

FIGS. 19A and 19B are diagrams that illustrate the display of expression levels from two samples.

FIG. 20A is a diagram that illustrates a cluster or view of expression levels.

FIG. 20B is a diagram that illustrates a cluster or view of relative expression levels.

FIGS. 21A, 21B, and 21C are diagrams that illustrate cluster view and expression levels of two samples.

FIG. 22 is a flow diagram that illustrates the processing of a component that displays a graphical representation of a gene product in one embodiment.

FIG. 23 is a flow diagram that illustrates the processing of a component that displays a graphical representation of subsequences of varying lengths in one embodiment.

FIG. 24 is a flow diagram that illustrates the processing of a component that displays a graphical representation of a gene product expression in one embodiment.

FIG. 25 is a flow diagram that illustrates the processing of component that displays a graphical representation of gene product profiles in one embodiment.

FIG. 26 is a flow diagram that illustrates the processing of a component that displays a graphical representation of expression levels for gene products in one embodiment.

### DETAILED DESCRIPTION

A. Graphical Representation of Gene Products

In one embodiment, the gene product representation technique starts by identifying a set of expected gene product sequences for a gene. The gene product sequences may include polynucleotides resulting from transcription and splicing, perhaps in the form of cDNAs or ESTs, or polypeptide sequences resulting from the translation of the expected transcripts. The gene product sequences are then aligned, either to each other or to a genomic sequence (a genomic alignment), such as a BAC, contig or chromosome. Sequence alignments can be performed using software tools such as sim4, ClustalW, BLAST and Smith-Waterman. From the multiple sequence alignment, coordinates are determined relative to the genomic sequence or to the other aligned sequences.

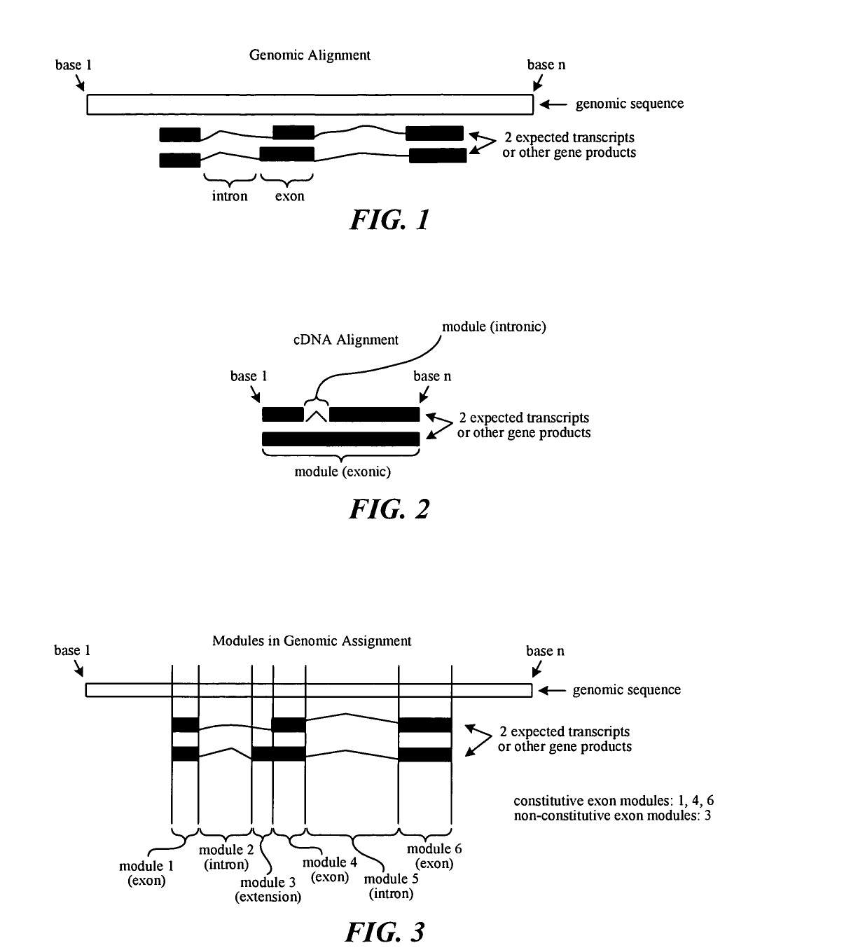

In the case of a genomic alignment, the coordinates identify the 3′ and 5′ ends of each exon as well as the 3′ and 5′ ends of each intron. (FIG. 1.) In the case where gene products are aligned to each other, such as a cDNA, EST or protein alignment, the coordinates identify the start and end of each gapped or non-gapped subsequence. (FIG. 2.) Such a subsequence constitutes a ‘module.’

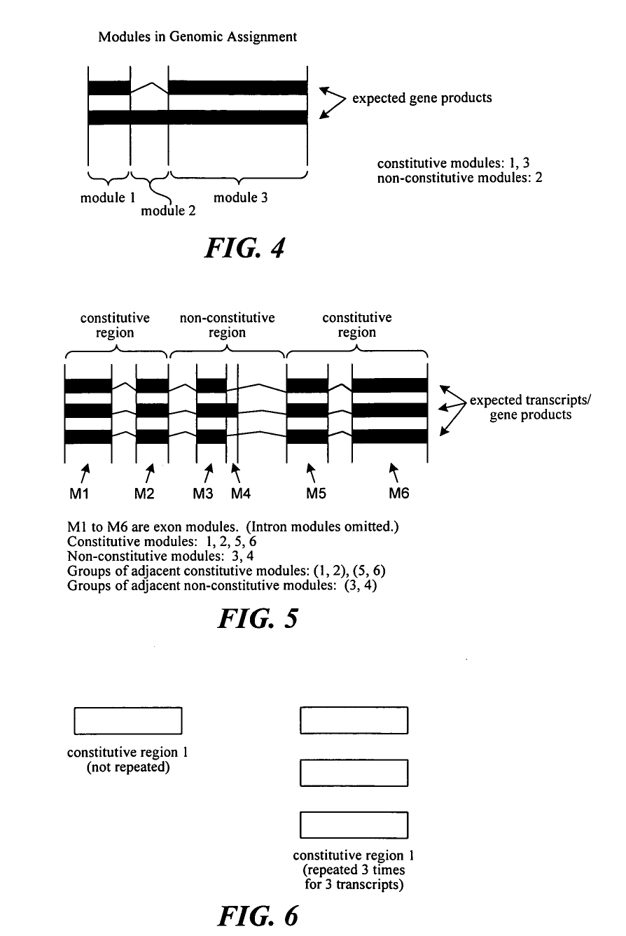

The representation technique considers the set of coordinates for the exons, introns or modules. The representation technique identifies a set of minimal modules that are non-overlapping. If one gene product includes a trimmed or extended exon, the trimmed or extended portion of the exon is one module, while the remainder of the exon is another module. In complex cases, there may be multiple possible trims or extensions of an exon. In one embodiment, the representation technique includes only exonic modules in the set of non-overlapping modules; in another embodiment, it includes both intronic and exonic modules. (FIG. 3 and FIG. 4.)

Within the set of minimal modules, the representation technique identifies modules that are constitutive and non-constitutive. Constitutive modules are present in all of the expected gene products, while non-constitutive modules are absent in one or more of the expected gene products. (FIG. 3 and FIG. 4.)

In one embodiment, the representation technique further identifies groups of adjacent modules that are constitutive and groups of adjacent modules that are non-constitutive. An individual constitutive module or a group of adjacent constitutive modules is a ‘constitutive region,’ while an individual non-constitutive module or a group of adjacent non-constitutive modules is a ‘non-constitutive region.’ (FIG. 5.)

For each constitutive region, the representation technique creates a graphical representation, such as a bar. In one embodiment, the representation technique displays a single graphical representation for each constitutive region (FIG. 6); in another embodiment, the representation technique repeats the representation once per expected gene product. (FIG. 6.) The representation technique may also display the gene product as a sequence of nucleotides or amino acids.

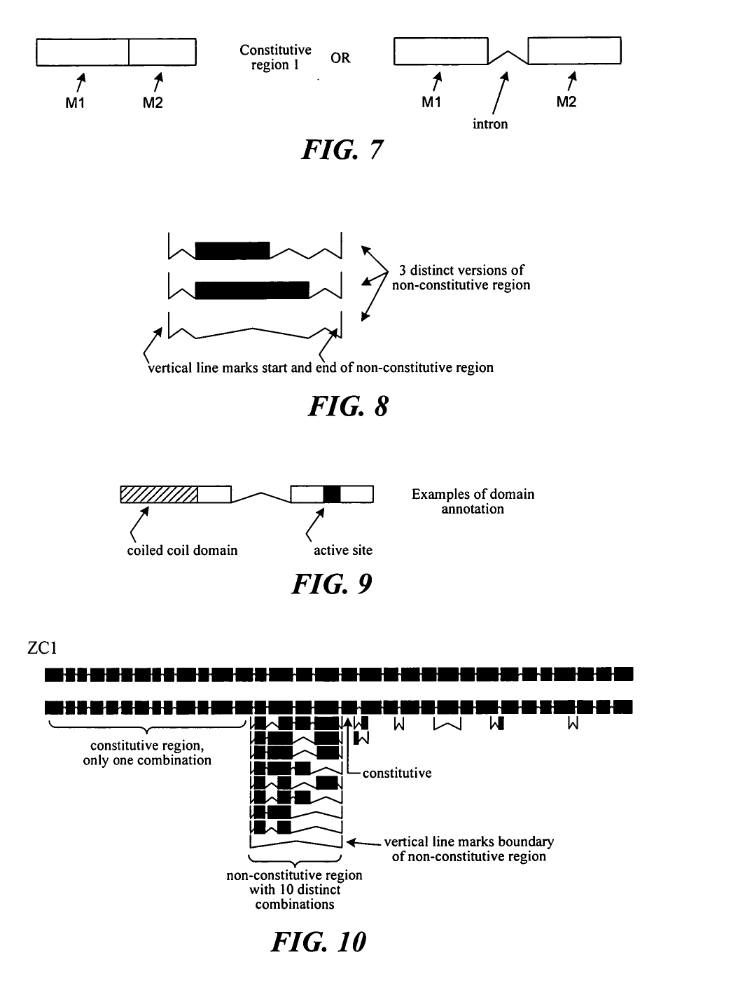

In one embodiment, the representation technique displays some or all of the exons and introns within a region (constitutive or non-constitutive) individually. (FIG. 7.)

For each non-constitutive region, the representation technique creates a graphical representation for each unique combination of modules that occurs in an expected gene product. (FIG. 8.) Alternatively, the representation technique may create a distinct graphical representation per gene product, regardless of uniqueness.

The representation technique may display the protein domain or domains for a region. (FIG. 9.)

The representation technique may display exons, introns and protein domains in the same view.

The representation technique may display a constitutive or non-constitutive region on a scale that is a function of the number of bases in the polynucleotide or polypeptide sequences of the exons and introns in that region (or on multiple scales as described below).

To highlight the start and end of a non-constitutive region, the representation technique may use a visual identifier, such as a vertical line at the 3′ or 5′ end of an intron; an arrow or series of arrows to link between regions; a vertical line that spans the display, marking the boundaries of the region; or it may color-code the modules within a region to distinguish them from adjoining regions. (FIG. 8.)

In one embodiment, the representation technique is implemented by means of a computer. It generates graphical images for print media or for display on a computer monitor or other display device. (FIG. 10.)

One skilled in the art will appreciate that when the representation technique is applied to the polypeptide translation of a polynucleotide splice variants, a given exon may be translated in multiple reading frames, and hence the polypeptide may be non-constitutive even if the polynucleotide is constitutive, because the amino acid sequence differs depending on the reading frame.

B. Graphical Representation of Subsequences of Varying Lengths

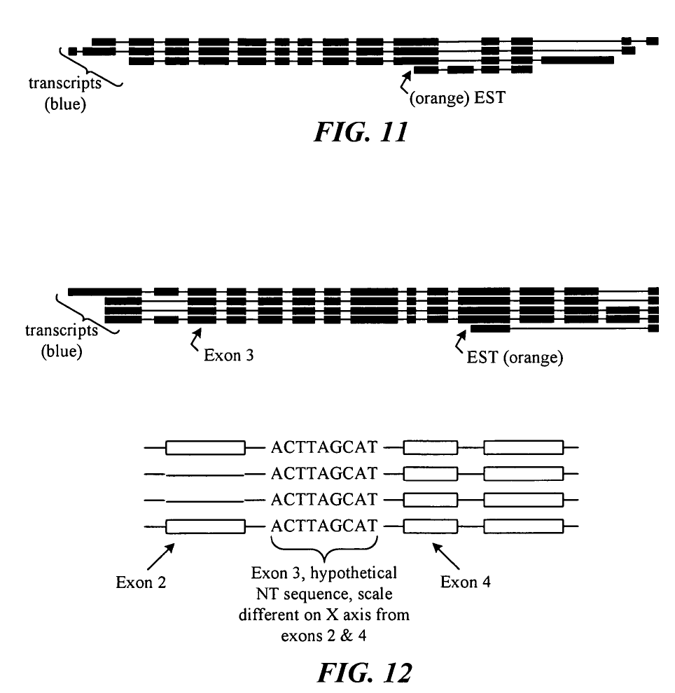

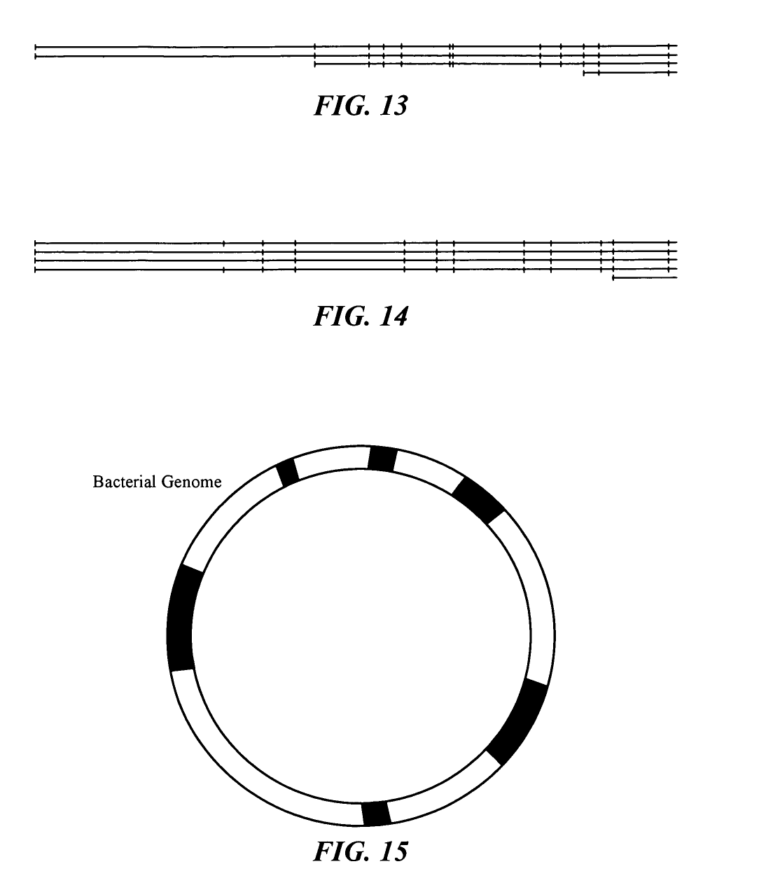

To address the problem of large differences in length between subsequences in a display, such as exons and introns, alternately spliced modules and large exons, or between categories of annotations, the gene product representation technique uses one or more scales within the same display. (See FIGS. 11, 12, 13 and 14.)

In one embodiment, the representation technique identifies subsequences of the polynucleotide or polypeptide sequences that are being displayed.

Possible examples include subsequences that span intronic regions common to all expected transcripts (the intronic modules of FIG. 3), or subsequences that span minimal modules, or span protein domains, or span a selected annotation or set of annotations.

The representation technique applies a mathematical function to the length each subsequence. In one embodiment, the function is a linear equation of the form:
Lₛ′=jₛ+kₛ*Lₛ
where Lₛ′ is the scaled length of subsequence S in some unit of measurement, such as pixels or millimeters; jₛ is a constant applied to subsequence S; kₛ is a scalar applied to subsequence S; and Lₛ is the original length of subsequence S in bases (nucleotide or peptide) or a unit of measurement such as pixels or millimeters.

In another embodiment, the function is a logarithmic equation of the form:
Lₛ′=jₛ+kₛ*log Lₛ
where Lₛ′ is the scaled length of subsequence S in some unit of measurement, such as pixels or millimeters; jₛ is a constant applied to subsequence S; kₛ is a scalar applied to subsequence S; and Lₛ is the logarithm of the original length of subsequence S in bases (nucleotide or peptide) or a unit of measurement such as pixels or millimeters. (FIGS. 11 and 12.)

In another embodiment, the representation technique uses an arbitrary equation of the form
Lₛ′=f (Lₛ)
where Lₛ′ is the scaled length of subsequence S in some unit of measurement, such as pixels or millimeters; f is an arbitrary equation; and Lₛ is the original length of subsequence S in bases (nucleotide or peptide) or a unit of measurement such as pixels or millimeters.

In one embodiment, the representation technique allows users to dynamically modify the scale. For example, when the user selects a specific annotation (such as a protein domain, an exon or an intron) a scalar function is applied to the subsequence for that annotation in order to “zoom in” on it. As another example, when the user selects a category of annotation (such as “exons,” “introns,” “SH domains,” “STS markers,” etc.), the representation technique alters the scalar function for the subsequences of those annotations.

The representation technique can be used for circular genomes, such as bacterial genomes, as well, with the effect of altering the length of the arc of the circle for each subsequence. (FIG. 15.)

C. Graphical Representations of Gene Product Expression

The gene product representation technique offers several ways to represent gene product expression. Gene product expression can be determined using a variety of techniques, including polymerase chain reaction (PCR), DNA-RNA or RNA-RNA hybridization, cloning, protein arrays, 2D-gels, and antipeptide antibodies. The representation technique can combine gene product expression with gene product sequences within a single graphical view.

D. Genome Browsers and Splice Graphs

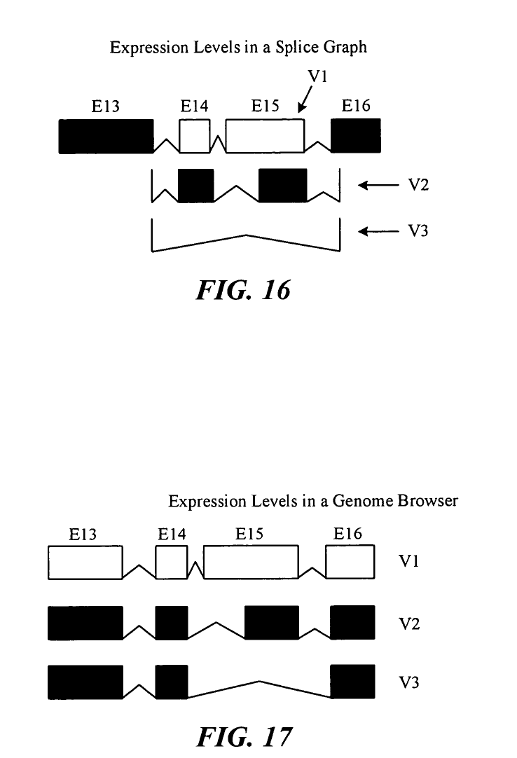

In one embodiment, the gene product representation technique combines gene product expression data with a genome browser or splice graph view of the gene product sequences. The representation technique indicates the expression level of a gene product, or region of a gene product, in the view in a graphical way. In one embodiment, it varies the color saturation of a portion of the gene product representation according to the expression level. The gene product representation may consist of a geometric shape, a text string, or a symbol, e.g., it may consist of multiple regions whose expression levels have been measured independently. (FIGS. 16 and 17.)

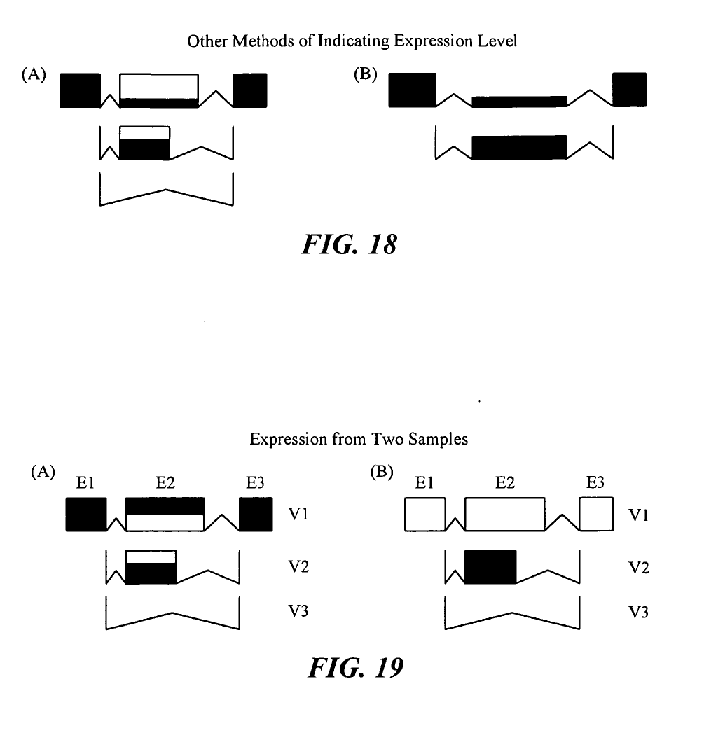

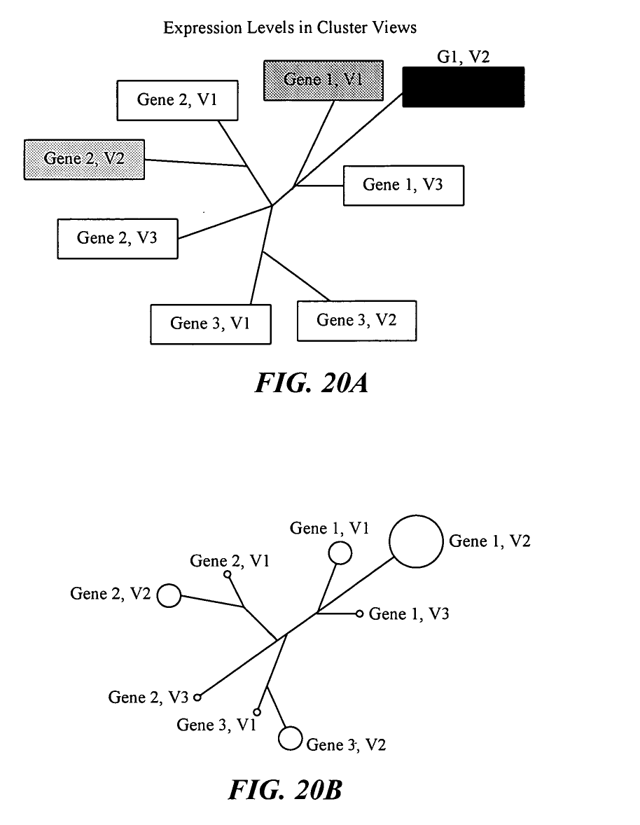

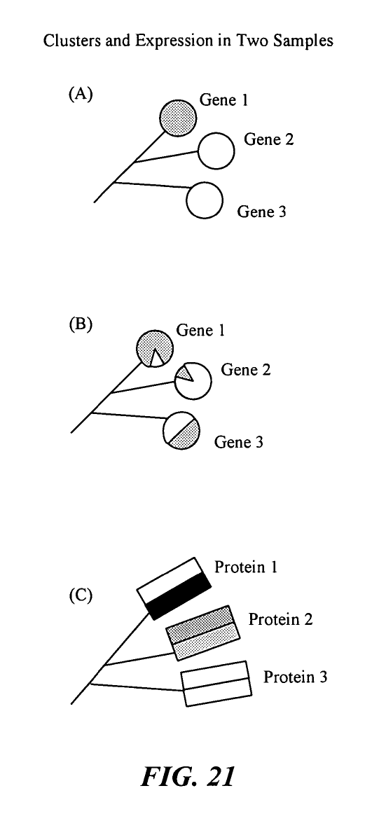

In another embodiment, the representation technique indicates the expression level by varying the color of a portion of the gene product representation. In another embodiment, the representation technique indicates the expression level by varying the “fill” of a portion of the gene product representation. In another embodiment, the representation technique indicates the expression level by varying the hue of a portion of the gene product representation. In another embodiment, the representation technique indicates the expression level by varying the brightness of a portion of the gene product representation. In another embodiment, the representation technique indicates the expression level by varying the transparency of a portion of the gene product representation. In another embodiment, the representation technique indicates the expression level by varying the size of the gene product representation. In another embodiment, the representation technique indicates the expression level through a combination of saturation, fill, hue, brightness, transparency and size. (FIG. 18.)

To display expression levels from more than two samples in the same display, the representation technique, in one embodiment, uses a different color for each sample. For example, if the expression level is greater in sample one than in sample two, the color might be green; if the expression level is greater in sample two than in sample one, the color might be red. If it is equal, the color might be white. (FIG. 19B.)

In another embodiment, the representation technique displays expression from two or more samples by allocating a portion of the gene product representation for each sample and independently varying the attributes of that portion. The color of each portion could be the same (e.g., green) or different (e.g., green for sample one, red for sample two). In one embodiment, the gene product representation is split horizontally into two portions; in the top portion, the expression level in sample one is displayed, and in the bottom portion, the expression level in sample two. The attributes within each portion are varied based on the expression level of the sample corresponding to that portion. (FIG. 19A.)

In another embodiment, the relative size of the portions is modified to indicate changes in expression level. In another embodiment, the representation technique displays more than two tissues by splitting a gene product representation into additional portions.

E. Representations of Gene Product Profiles

In one embodiment, the gene product representation technique creates a profile for a given gene product of a gene across multiple samples in the form of a vector. More than one such vector can be displayed in a matrix, e.g., as rows in a spreadsheet.

When a gene may produce multiple expected gene products, the representation technique identifies constitutive and non-constitutive regions of the expected gene products, as described above. For each non-constitutive region, the representation technique identifies the unique sequences (polynucleotide sequences in the case of RNA transcripts, or polypeptide sequences in the case of protein translations) or unique combinations of modules that span the region. Each unique sequence or combination of modules is a ‘variant’ of that region. The representation technique creates a vector for each variant in a non-constitutive region.

For example, if a gene has four independent non-constitutive regions (regions where alternate splicing can occur), and there are two expected variants per non-constitutive region, the gene has 2⁴ expected gene products. The representation technique identifies each of the four independent regions as non-constitutive regions.

A gene may have more than two expected variants per non-constitutive region. Also, non-constitutive regions may be interdependent. For example, region one may have two variants, and region two may have two variants. Region one, variant one and region two, variant two may tend to occur in the same gene product. In such a case, the mutually interdependent regions may be grouped together to form a single independent non-constitutive region.

The gene product representation technique measures gene product expression for the expected variants of a non-constitutive region in one or more samples. Techniques for measuring gene product expression include polymerase chain reaction (PCR), oligonucleotide arrays, protein arrays and 2D-gels. The representation technique selects probes specific to the non-constitutive region and expected variant. E.g., in the case of an oligonucleotide array or PCR experiment, the technique selects indicator polynucleotides that selectively hybridize to the exons or exon-exon junctions of a given variant in the non-constitutive region.

If the representation technique selects multiple probes for the expected variant in the non-constitutive region, the technique may combine the measured values from these probes into a single value. For example, it may use the average or geometric mean of the measured values.

If the representation technique selects probes that detect more than one variant in the non-constitutive region, it may use a system of linear equations or a least squares algorithm to determine which expected variants are expressed and in what quantities given the set of probes selected. (See U.S. patent application Ser. No. 10,146,720, entitled “Method and System for Identifying Splice Variants of a Gene,” and filed on May 14, 2002, which is hereby incorporated by reference.)

Given the expression values, the gene product representation technique creates a vector for each variant of each non-constitutive region. In the example above, it would create a total of 8 vectors for the 4 non-constitutive regions. In one embodiment, the representation technique also creates a single vector for all of the constitutive regions. Such a vector is a gene expression profile.

| | | | Sample 1 | Sample 2 |
|---|---|---|---|---|
| Gene | Region | Variant | Expression | Expression |
| JVN-G1 | 1 | 1 | 1944 | 1533 |
| JVN-G1 | 1 | 2 | 206 | 883 |
| JVN-G1 | 2 | 1 | 5006 | 0 |
| JVN-G1 | 2 | 2 | 0 | 2448 |
| JVN-G1 | 3 | 1 | 449 | 404 |
| JVN-G1 | 3 | 2 | 2218 | 1896 |
| JVN-G1 | 4 | 1 | 449 | 404 |
| JVN-G1 | 4 | 2 | 2218 | 1896 |
| JVN-G1 | NA | All | 1446 | 1885 |

The representation technique may include vectors from multiple genes in a single matrix.

In one embodiment, the representation technique uses the expression level from the constitutive regions to scale the expression levels of each non-constitutive region, so that the sum of the expression levels from the expected variants in each non-constitutive region equals the expression level from the constitutive regions. The table above would change to the following:

| | | | Sample 1 | Sample 2 |
|---|---|---|---|---|
| Gene | Region | Variant | Expression | Expression |
| JVN-G1 | 1 | 1 | 1307 | 1196 |
| JVN-G1 | 1 | 2 | 139 | 689 |
| JVN-G1 | 2 | 1 | 1446 | 0 |
| JVN-G1 | 2 | 2 | 0 | 1885 |
| JVN-G1 | 3 | 1 | 243 | 331 |
| JVN-G1 | 3 | 2 | 1203 | 1554 |
| JVN-G1 | 4 | 1 | 243 | 331 |
| JVN-G1 | 4 | 2 | 1203 | 1554 |
| JVN-G1 | NA | All | 1446 | 1885 |

The representation technique uses the gene product vectors in statistical analyses to analyze gene product profiles. Techniques include any of those used for gene expression analysis and protein expression analysis, including principle component analysis, grouping, correlation, Euclidean distance, self-organizing maps and hierarchical clustering.

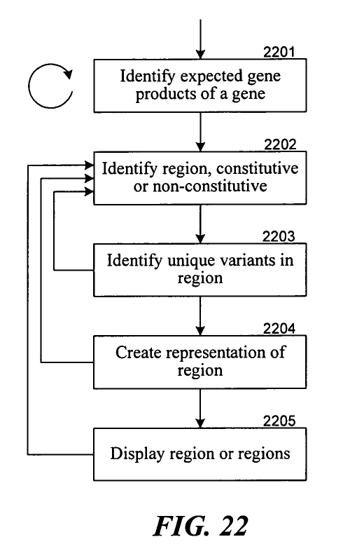

FIG. 22 is a flow diagram that illustrates the processing of a component that displays a graphical representation of a gene product in one embodiment. In block 2201, the component loops identifying all the expected gene products of the gene. In block 2202, the component identifies a constitutive and non-constitutive region of the identified gene products. In block 2203, the component identifies the unique a variance of the region. In block 2204, the component creates a representation of the identified region. In block 2205, the component displays the region and then loops to block 2202 to identify another region.

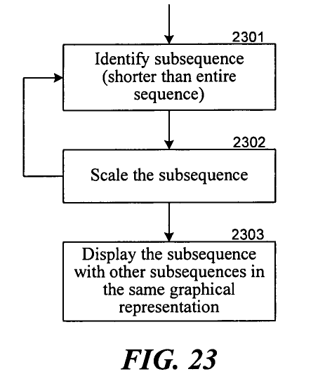

FIG. 23 is a flow diagram that illustrates the processing of a component that displays a graphical representation of subsequences of varying lengths in one embodiment. In block 2301, the component identifies subsequences that are shorter than the entire sequence. In block 2302, the component scales the identified subsequences and loops to block 2301 identify the next subsequence. If all the subsequences have been identified, the component continues at block 2303. In block 2303, the component displays the scaled subsequences simultaneously. The component then completes.

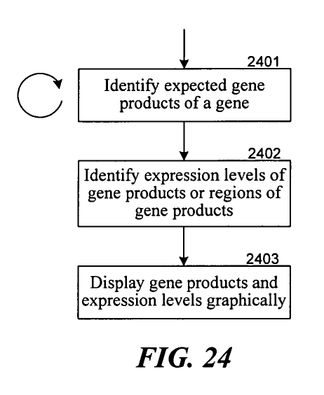

FIG. 24 is a flow diagram that illustrates the processing of a component that displays a graphical representation of a gene product expression in one embodiment. In block 2401, the component loops identifying expected gene products of a gene. In block 2402, the component identifies the expression levels of the identified gene products or regions of the gene products. In block 2403, the component displays the gene products and expression levels graphically and then completes.

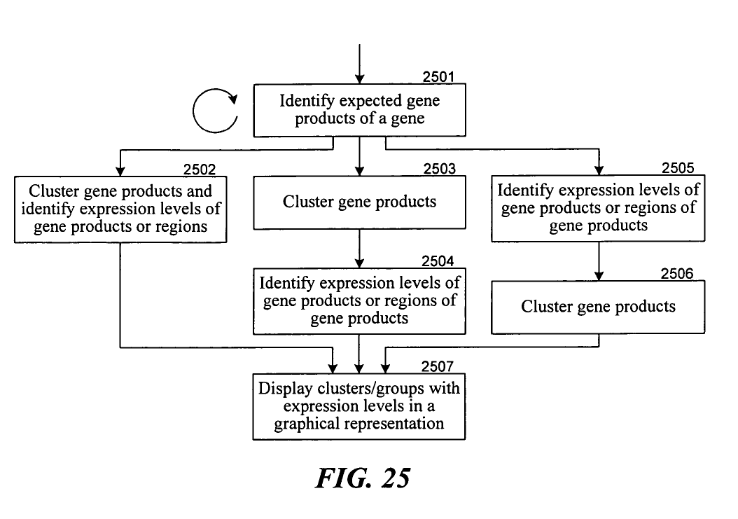

FIG. 25 is a flow diagram that illustrates the processing of component that displays a graphical representation of gene product profiles in one embodiment. In block 2501, the component loops identifying the expected gene products of a gene. Depending on the type of clustering and expression level that has been selected by a user, the component continues at blocks 2502, 2503, or 2505. In block 2502, the component clusters the gene products and identifies the expression level of the gene products. In blocks 2503-2504, the component clusters the gene products and identifies expression levels of gene products or regions of the gene product. In blocks 2505-2506, the component identifies expression levels of the gene product or region of gene products and clusters the gene products. In block 2507, the component displays the clusters and groups with the expression levels in a graphical representation and then completes.

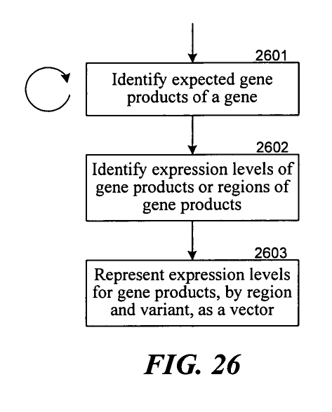

FIG. 26 is a flow diagram that illustrates the processing of a component that displays a graphical representation of expression levels for gene products in one embodiment. In block 2601, the component loops identifying the expected gene products of the gene. In block 2602, the component identifies expression levels of the gene product or regions of gene products. In block 2603, the component represents the expression levels for gene product by region and variant as a vector. The component then displays the representation and completes.

The computing device on which the representation system is implemented may include a central processing unit, memory, input devices (e.g., keyboard and pointing devices), output devices (e.g., display devices), and storage devices (e.g., disk drives). The memory and storage devices are computer-readable media that may contain instructions that implement the representation system. In addition, the data structures and message structures may be stored or transmitted via a data transmission medium, such as a signal on a communications link. Various communications links may be used, such as the Internet, a local area network, a wide area network, or a point-to-point dial-up connection.

The representation system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

One skilled in the art will appreciate that although specific embodiments of the representation system have been described herein for purposes of illustration, various modifications may be made without deviating from the spirit and scope of the invention. Accordingly, the invention is not limited except by the appended claims.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

1. A method in a computer system for displaying a graphical representation of gene variants of a tissue sample, the gene having an exonic structure, the method comprising:
displaying representation of the exonic structure; and
for each of a plurality of gene variants, displaying a representation of the gene variant wherein the exons of the gene variant are aligned with corresponding exons of the exonic structure and wherein the displayed representation indicates relative expression level of the gene variant.

2. The method of claim 1 wherein the relative expression level is indicated by intensity level of a color.

3. The method of claim 1 wherein the relative expression level is indicated by shading of an area corresponding to the gene variant.

4. The method of claim 1 wherein representations of gene variants for multiple tissue samples are displayed simultaneously.

5. The method of claim 4 wherein the representations for different tissue samples are displayed in different colors.

6. The method of claim 1 wherein each gene variant is represented by a rectangular region for each exon with a width corresponds to the length of the exon.

7. The method of claim 6 wherein the relative expression level is indicated by height of the rectangle.

8. A method in a computer system for displaying a graphical representation of gene variants of a tissue sample, the method comprising:
for each of a plurality of gene variants, displaying a representation of the gene variant wherein exons of the gene variant are aligned with corresponding exons of the other gene variants and wherein the displayed representation indicates relative expression level of the gene variant.

9. The method of claim 8 wherein the relative expression level is indicated by intensity level of a color.

10. The method of claim 8 wherein the relative expression level is indicated by shading of an area corresponding to the gene variant.

11. The method of claim 8 wherein representations of gene variants for multiple tissue samples are displayed simultaneously.

12. The method of claim 11 wherein the representations for different tissue samples are displayed in different colors.

13. The method of claim 8 wherein each gene variant is represented by a rectangular region for each exon with a width corresponds to the length of the exon.

14. The method of claim 13 wherein the relative expression level is indicated by height of the rectangle.
